(19) United States
(12) Patent Application Publication
(10) Pub. No.: US 2009/0063269 A1
(43) Pub. Date: Mar. 5, 2009

(54) System and Method for Freemium Based Marketing

(75) Inventors: John J. Barnes, Weston, FL (US); Joshua Goff, Mercer Island, WA (US)

Correspondence Address: BROMBERG & SUNSTEIN LLP, 125 SUMMER STREET, BOSTON, MA, 02110-1618, US

(73) Assignee: CROSS COUNTRY HOME SERVICES, INC., Sunrise, FL (US)

(21) Appl. No.: 11/850,389

(22) Filed: Sep. 5, 2007

(51) Int. Cl. G06Q 30/00

(52) U.S. Cl. 705/14

(57) ABSTRACT

A method of freemium based marketing includes providing a utility consumer with an offer for a freemium requiring the consumer to respond to the offer. When the consumer responds to the offer, consumer data is collected and a bundle of additional consumer products are selected based on the consumer data. The bundle of additional products may include home service products. The method then offers the consumer an opportunity to purchase products from the selected bundle. The method then provides the user with the freemium.

### FIELD OF THE INVENTION

The invention generally relates to marketing methods, more particularly, the invention relates to systems and methods for freemium based marketing.

### BACKGROUND

With the rising cost of energy, the need for energy efficiency is greater than ever. To that end, the Department of Energy (“DOE”) and utility companies across the country are creating programs that promote energy efficiency. In many instances, government regulations require utility companies to develop such programs. These programs are designed to educate consumers about energy efficiency by providing them with information and literature. Additionally, many of the programs offer rebates, discounts, and other incentives for those consumers who are energy conscious and willing reduce their energy consumption.

As one can imagine, the costs associated with the above mentioned programs can be high. Additionally, some consumers may be wary of programs designed to lower energy costs because the very company that sells the energy sponsors the programs. Therefore, many utility companies need to develop creative, yet cost effective strategies and programs to promote energy efficiency to residential and industrial consumer, and meet the above mentioned requirements.

### SUMMARY OF THE INVENTION

In accordance with embodiments of the present invention, a method of freemium based marketing is used. The method includes providing a utility consumer with an offer for a freemium that requires the consumer to respond to the offer. When the consumer responds to the offer, the method collects consumer data. Based on the consumer data, the method may select a bundle of additional products including home service products, and offer the consumer an opportunity to purchase products from the selected bundle. The method then provides the user with the freemium, whether or not the user purchases products from the bundle. The freemium can be a number of products or services including, but not limited to, free access to a network of service technicians.

In some embodiments, the method may also integrate at least one utility program and at least one home service program. The integration of the utility program and the home service program creates a single platform, such as an energy efficiency platform. The home service programs can be programs such as administrative programs, customer service programs, service network programs, contract referral network programs, rebate programs, line protection programs, repair, replacement and/or maintenance programs, recycling programs, green energy programs, carbon credit programs, and installation service programs. The utility programs can be programs such as surge programs, load control programs, energy audit programs, thermostat programs, appliance upgrade programs, and energy efficiency information programs.

In other embodiments, the method bundles future products and services based on the consumer data and offers the future products and services to the consumer associated with the consumer data. The future products and services may include, but are not limited to, equipment purchase services, equipment upgrade services, equipment maintenance services, energy use monitoring products, and energy use monitoring services.

In still other embodiments, the method may increase the marketing credibility and/or increasing a value perception of the utility company prior to providing or offering the freemium. In such embodiments, increasing the marketing credibility of a utility company may include providing consumers with information on energy efficiency, providing consumers with tips regarding energy efficiency, and providing consumers with low cost products and services.

In accordance with other embodiments, a method of freemium-based marketing provides a utility consumer with an offer for a freemium that requires the consumer to respond to the offer. The freemium may be enrollment in a home service referral network. When the consumer responds, the method may collect consumer data, and offer the consumer an opportunity to purchase additional products and services based on the consumer data. The method may then provide the user with the freemium.

In accordance with other embodiments of the present invention, a system may implement the freemium based marketing techniques described above. The system may include a series of interconnected modules and components. Specifically, the system may include a freemium offer module, an offer acceptance module, a data collection module, a product and service selection module, and a freemium provider module. The freemium offer module provides the utility consumer with the offer for the freemium. The data collection module collects the consumer data when the consumer responds to the offer. The product and service selection module selects the bundle of consumer products, including a home service product, based on the consumer data, and offers the consumer an opportunity to purchase products from the bundle. The freemium provider module provides the consumer with the freemium.

The system may also include a program integrator for integrating at least one utility program with at least one home service program. By doing so, the integrator creates a single platform for the at least one utility program and the at least one home service program. Further, the system may also include a database generator and a product and service bundler. The database generator generates a database including the consumer data. The product and service bundler bundles future products and services based on the consumer data contained within the database, and offers the future products and services to the consumer associated with the consumer data.

In accordance with other system embodiments, the freemium may be enrollment into a home service referral network, and the product and service selection module may select additional products and services based on the consumer data. The product and service selection module may then offer the consumer an opportunity to purchase the additional products and service.

### BRIEF DESCRIPTION OF THE DRAWINGS

The foregoing features of the invention will be more readily understood by reference to the following detailed description, taken with reference to the accompanying drawings, in which:

FIG. 1 schematically shows the entities and interactions involved with methods and systems in accordance with embodiments of the present invention.

FIG. 2 shows a flowchart showing the steps of one method of freemium based marketing in the utility industry in accordance with one embodiment of the invention.

FIG. 3 shows a flowchart showing the steps of a second method of freemium based marketing in the utility industry in accordance with another embodiment of the invention.

FIG. 4 shows an exemplary integrated energy efficiency platform developed following the method shown in FIG. 3.

FIG. 5 schematically shows a system for freemium based marketing in the utility industry in accordance with embodiments of the present invention.

### DESCRIPTION OF ILLUSTRATIVE EMBODIMENTS

Definitions. As used in this description and the accompanying claims, the following terms shall have the meanings indicated, unless the context otherwise requires:

Utility Industry: A company, municipality, cooperative or other organization that provides a public service, such as producing, transmitting, distributing, or otherwise supplying electricity, natural gas, propane gas, water, sewage disposal, telephone, cable, internet, wireless service, or any such combination, thereof, or any other similar works or systems necessary to the public interest.

Freemium: A free product or service offered to a consumer for the purpose of gathering data and/or offering additional products and/or services at a charge.

Embodiments of the present invention provide a system and method for using freemium based marketing in the utility industry. Specific embodiments offer a utility consumer a freemium that requires the consumer to respond to the offer. The method and system may then use the offer for a freemium to collect additional consumer information, offer or market additional products and services to the consumer, and, perhaps, develop a cost effective, integrated energy efficiency platform. Details of illustrative embodiments are discussed below.

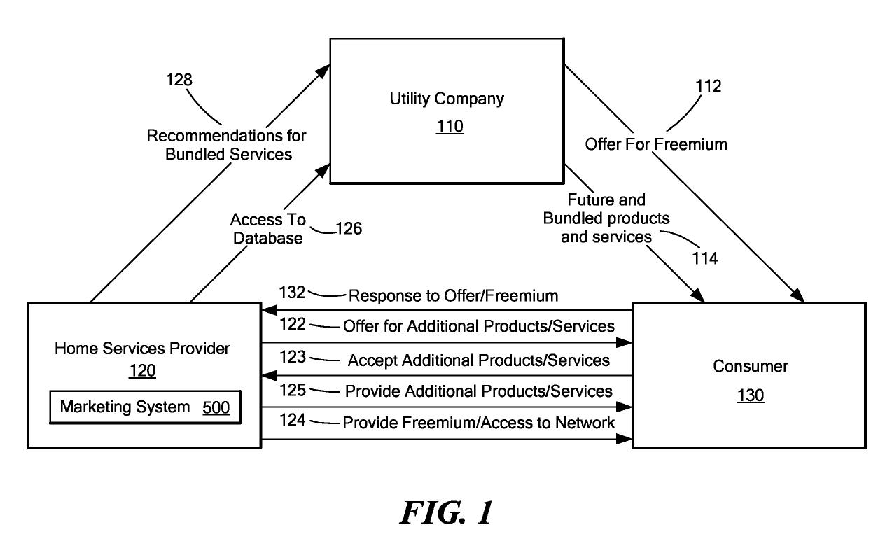

As shown in FIG. 1, embodiments of the present invention involve interactions between three entities—a utility company 110, a home service provider 120, and a utility consumer 130. During practice of the methods described herein, each entity may perform specific tasks and interact with the other entities. Each of these tasks and interactions will be described in greater detail below. Additionally, although FIG. 1 shows a home service provider 120 and a utility company 110, in some embodiments of the present invention, the utility company 110 may perform all of the functions of the utility company 110 and home service provider 120 shown in FIG. 1. In such embodiments, the home service provider 120 is not required, and all interactions will be between the consumer 130 and the utility company 110.

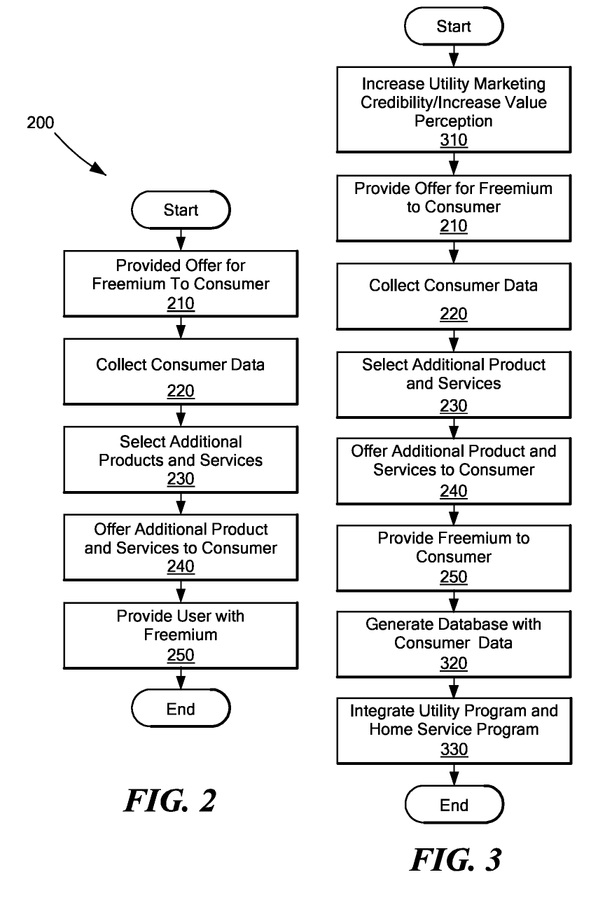

FIG. 2 shows one embodiment of a method in accordance with the present invention. According to the method 200, the utility company 110 first offers a freemium to a utility consumer (Step 210). The freemium can be any number of free products or services. For example, the freemium may be a product such as a free energy efficient light bulb. Alternatively or additionally, the freemium can be a free service, such as free access to a network of service technicians and/or enrollment in a home service referral network. To receive the freemium, the utility consumer 130 must respond to the offer by contacting the home service provider 120 or the utility company 110. The consumer 130 can respond to the freemium offer in a number of ways including, but not limited to, calling the home service provider 120, calling the utility company 110, or filling out an on-line form on either the home service provider's website or the utility company's website.

When the consumer 130 responds to the offer (e.g., when the consumer 130 calls the home service provider 120 or utility company 110, or fills out the on-line form), the entity receiving the response (e.g., the home service provider 120 or the utility company 110) collects data from the consumer prior to providing the user with the freemium (Step 220). Examples of the information collected include information relating to the consumer's home appliances (e.g., type, make, model, age etc.), the consumer's energy usage (e.g., amount of usage, peak usage times, etc.), and the consumer's energy beliefs (e.g., desire to be more energy efficient, feelings about utility provider, etc.).

Based on the collected consumer data, the method 200 selects additional products and services (Step 230) and offers these additional products and services to the consumer 130 (Step 240). These additional products and services are offered to the consumer 130 at an additional charge (e.g., they are not free to the consumer like the freemium). As mentioned above, the additional products and services offered at the time of activation are based on the gathered consumer data. Therefore, the method 200 can tailor the products and services to the individual consumer. For example, the products and services can be replacement parts or a service contract for the consumer's 130 specific appliances.

Additionally, in some embodiments, the method may bundle the additional products and services. The method may then offer the consumer an opportunity to purchase products from the bundle. The bundle of products and service can include, among other things, home service products and services. Once the method 200 offers the additional products and services (or the bundle of products and services) to the consumer 130, the method 200 provides the user with the freemium (Step 250). It is important to note that the method 200 activates the freemium whether or not the consumer 130 purchases the additional products and services.

Although FIG. 2 shows the method as essentially a five step process, other embodiments of the present invention can include additional steps, as shown in FIG. 3. In particular, some embodiments increase the marketing credibility of the utility company 110 prior to offering the freemium (Step 310). As mentioned above, many consumers may be wary of, unaccustomed to, or unaware of energy efficiency products and services offered by the utility company 110. Therefore, in some cases it may be necessary to accustom the utility consumers 130 to the idea that their utility company 110 cares about more than just sending the consumer 130 a bill and collecting on that bill. In particular, increasing the marketing credibility can demonstrate to the consumers that the utility company 110 cares about energy efficiency and helping the consumer 130 reduce their energy costs on a monthly basis.

A number of techniques can be used to increase the marketing credibility of the utility company 110. For example, the utility company can include tips and materials regarding energy efficiency within the monthly billing statements or can provide low-cost products and services. Additionally, the utility company 110 can provide additional products and services that are popular with consumers and close to their core business or offer support with energy efficiency (e.g., the utility company can work with the consumer to help them become more energy efficient, provide free energy usage audits, etc.). During this time, the utility company 120 can collect additional consumer data (e.g., in addition to the data collected during Step 220).

In addition to increasing the marketing credibility of the utility company 110, the techniques described above may also increase the consumer's value perception of the utility company. In other words, the consumer 130 may begin to perceive the utility company 110 as providing a greater value than simply providing them with the utility.

Additionally, some embodiments of the method described above may generate a database (Step 320 in FIG. 3) containing any consumer data collected (e.g., when the consumer 130 activates the freemium offer and during the “increasing marketing credibility/value perception” stage). The database may include information such as the consumers name, address, appliance information (e.g., make, model, type, age, etc.), energy usage information, energy belief information, etc. The home service provider 120 and the utility company 110 can use the database to select and bundle future products and services that may be offered to the consumer 130. For example, the home service provider 120 or the utility company 110 can bundle any number of the following products and services: equipment purchase services, equipment upgrade services, equipment maintenance services, energy use monitoring services, and energy use monitoring products, to name but a few.

As shown in FIG. 3, some embodiments may also integrate utility programs and home service programs. In some embodiments, the utility company 110 may provide the utility programs and the home service provider 120 can provide the home service programs. However, in other embodiments, the utility company 110 may provide some or all of the home service programs. Likewise, the home service provider 120 may provide some or all of the utility programs. The home service and utility programs can be integrated into a single platform, such as an energy efficiency platform that can benefit the consumer 130 as well as the utility company 5 110. The utility company programs can include equipment purchasing and replacement programs, re-cycling programs, surge programs, load control programs, energy audit programs, thermostat programs, appliance upgrade programs, energy efficiency information programs, etc. The home service provider programs can include administrative programs, customer service programs, service technician network programs, contract referral network programs, rebate programs, line protection programs, repair and maintenance programs, recycling programs, green energy programs, carbon credit programs, installation service programs, etc. The integrated platform leverages the administrative, and service and network programs with the data collected to provide a single energy efficiency platform that is cost effective for the utility company 110 and provides valuable information and services to the consumer 130.

Although a few examples of the utility company and home service provider programs are mentioned above, these are provided for illustrative purposes only. Additional programs may be within the scope of this invention and can be integrated with the programs discussed above. For example, additional programs may include device based A/C, heating, water heater, and pool pump control, filter programs, in-home energy audits, rebate programs, and customer service programs, to name but a few.

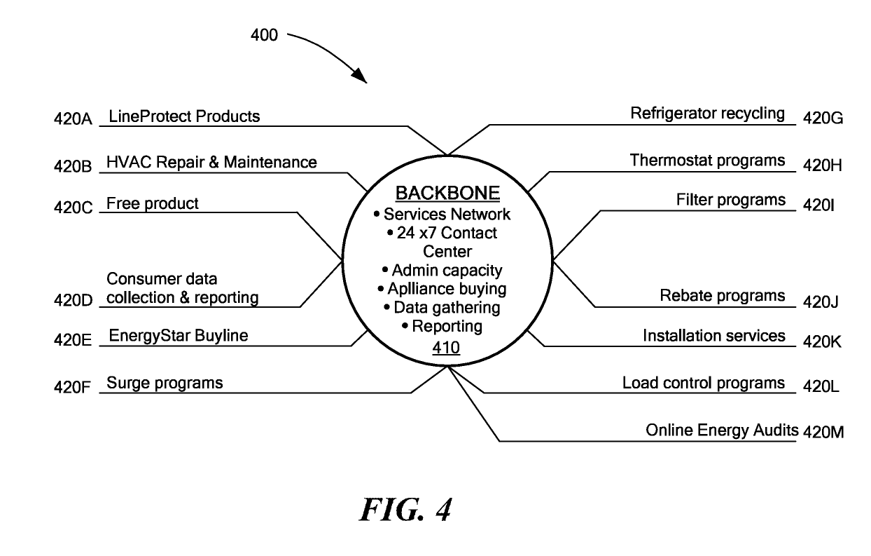

As mentioned above, utility and home service programs can be integrated into a single platform. FIG. 4 shows an example of such an integrated energy efficiency platform. In this embodiment, the integrated platform 400 includes a backbone 410 and a plurality of utility and home service programs 420A-M. The backbone may include a service network, a 24-7 contact center, administrative capacity, appliance buying services, data gathering services, and reporting services. The backbone elements are typically, but not necessarily, provided by the home service provider 120. As mentioned above, the backbone 410 is integrated with a variety of programs 420A-M to provide a single energy efficiency platform.

Returning to FIG. 1, the interactions between each of the above described entities are now discussed in greater detail. First, the utility company 110 offers a freemium to the consumer 130 (interaction 112). The utility company 110 can provide the freemium offer to the consumer 130 in a number of ways including sending the offer within the monthly billing statement, mailing the offer within a newsletter, calling the consumer 130 and providing the offer by phone, or providing the offer via e-mail. Once the consumer 130 receives the offer and decides to respond to the offer, the consumer 130 contacts the home service provider 120 to respond (interaction 132). During the response process, the home service provider 120 may collect data, select additional products and services, and offer the additional products and services to the consumer 130 (interaction 122). If the consumer 130 accepts/purchases the additional products and services (interaction 123), the home service provider 120 will provide the consumer 130 with the purchased products and services (interaction 125). Whether or not the consumer 130 purchases some or all of the additional products and/or services, the home service provider 120 will provide the consumer 130 with the freemium. In preferred embodiments, providing the consumer 130 with the freemium includes providing the consumer 130 with access to a network of service technicians (interaction 124).

As mentioned above, the marketing system can generate a database that contains the consumer information collected during freemium activation. The home service provider 120 can provide the utility company 110 with access to the database (interaction 126) or the home service provider 120 can provide the utility company 110 with recommendations for future bundled products and services based on the information within the database (interaction 128). The utility company 110 can then offer the future and bundled products and services to the consumer 130 (interaction 114).

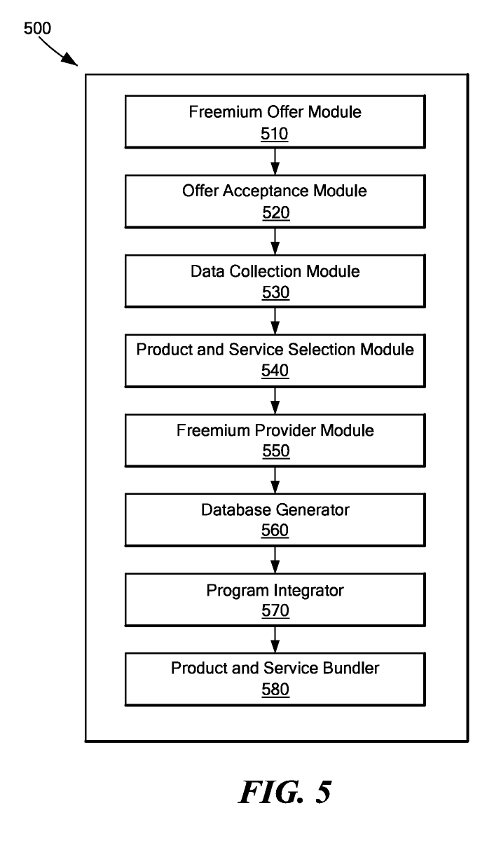

As mentioned above and as shown in FIGS. 1 and 5, some embodiments of the present invention can be implemented as a system 500. The system 500 can include a variety of interconnected modules that perform the functions and steps discussed above with respect to FIGS. 1, 2, and 3. In particular, the system 500 may include a freemium offer module 510 that determines the freemium to offer, and offers the freemium to the consumer 130. When the consumer 130 contacts the home service provider 120 to respond to the offer/freemium, an offer acceptance module 520 receives the response notification and notifies a data collection module 530. The data collection module 530 then begins to collect the consumer data described above.

Based on the data collected by the data collection module 530, a product and service selection module 540 selects the additional products and services and offers these additional products and services to the consumer 130. Additionally or alternatively, the product and service selection module 540 may bundle the additional products and services, and offer the consumer 130 an opportunity to purchase products (including home service products) from the bundle. Once the consumer 130 either purchases or refuses the additional products and services, an freemium provider module 550 provides the consumer 130 with the freemium (e.g., provides the consumer 130 with access to the network of technicians).

A database generator 560 in communication with the data collection module 530 generates the database containing the collected consumer data described above. A product and service bundler 580 can then use the information contained within the database to select and bundle future services that the home service provider 120 or utility company 110 can offer to the consumer 130 at a later time. As mentioned above, because the bundled products and services are based on the consumer data within the database, the products and services may be targeted to the specific consumer. Lastly, the system 500 can include a program integrator 570 that integrates the home service programs and the utility company programs into a single platform, as shown in FIG. 4.

Although the system described above with respect to FIG. 5 is illustrated as a single system located in a single location (e.g., within the home service provider 120 as shown in FIG. 1). The individual system components can be located in the home service provider 120, the utility company 110, or a combination of the two. For example, the offer acceptance module 520, the data collection module 530, the product and service selection module 540, the freemium module 550, the database generator 560, and the program integrator 570 may be located with the home service provider 120. Therefore, the freemium offer module 510, and the product and service bundler 580 may be located with the utility company 110.

It is important to note that, although the above described embodiments are discussed with regard to the utility and home service industries, embodiments of the present invention may be used in other industries. For example, some embodiments of the methods and systems may be used in the mortgage servicing industry, the real estate industry, membership club and organization industry, the financial service industry, or the banking industry, to name but a few.

Although the above discussion discloses various exemplary embodiments of the invention, it should be apparent that those skilled in the art can make various modifications that will achieve some of the advantages of the invention without departing from the true scope of the invention.

What is claimed is:

1. A method of freemium-based marketing comprising:
providing to a utility consumer an offer for a freemium requiring the consumer to respond to the offer;
collecting consumer data when the consumer responds to the offer;
selecting a bundle of additional consumer products including home service products based on the consumer data;
offering the consumer an opportunity to purchase products from the selected bundle; and
providing the user with the freemium

2. A method according to claim 1, further comprising:
after providing the user with the freemium, integrating at least one utility program and at least one home service program, thereby creating a single platform for the at least one utility program and at least one home service program.

3. A method according to claim 2, wherein the at least one home service program includes at least one of: an administrative program, a customer service program, a service network program, a contract referral network program, a rebate program, a line protection program, a repair, replacement and/or maintenance program, a recycling program, a green energy program, a carbon credit program, and an installation service program.

4. A method according to claim 2, wherein the at least one utility program includes at least one program selected from a group consisting of: a surge program, a load control program, an energy audit program, a thermostat program, an appliance upgrade program, and an energy efficiency information program.

5. A method according to claim 1 further comprising:
bundling future products and services based on the consumer data; and
offering the future products and services to the consumer associated with the consumer data.

6. A method according to claim 5, wherein the future products and services include at least one selected from the group consisting of: equipment purchase services, equipment upgrade services, equipment maintenance services, energy use monitoring products, and energy use monitoring services.

7. A method according to claim 1, wherein the freemium includes free access to a network of service technicians.

8. A method according to claim 1 further comprising increasing the marketing credibility of a utility company prior to providing the freemium.

9. A method according to claim 8, further comprising increasing a value perception of the utility company

10. A method according to claim 8, wherein increasing the marketing credibility of a utility company includes at least one selected from the group consisting of: providing consumers with information on energy efficiency, providing consumers with tips regarding energy efficiency, and providing consumers with low cost products and services.

11. A method according to claim 2, wherein the single platform is an energy efficiency platform.

12. A method of freemium-based marketing comprising:
providing to a utility consumer an offer for a freemium requiring the consumer to respond to the offer, wherein the freemium is enrollment in a home service referral network;
collecting consumer data when the consumer responds to the offer;
offering the consumer an opportunity to purchase additional products and services based on the consumer data; and
providing the user with the freemium.

13. A method according to claim 12, further comprising:
after providing the user with the freemium, integrating at least one utility program and at least one home service program, thereby creating a single platform for the at least one utility program and at least one home service program.

14. A method according to claim 13, wherein the at least one home service program includes at least one program selected from a group consisting of: an administrative program, a customer service program, a service network program, a contract referral network program, a rebate program, a line protection program, a repair and maintenance program, a recycling program, a green energy program, a carbon credit program, and an installation service program.

15. A method according to claim 13, wherein the at least one utility program includes at least one program selected from a group consisting of: a surge program, a load control program, an energy audit program, a thermostat program, an appliance upgrade program, or an energy efficiency information program.

16. A method according to claim 12 further comprising:
bundling future products and services based on the consumer data; and
offering the future products and services to the consumer associated with the consumer data.

17. A method according to claim 16, wherein the future products and services include at least one selected from the group consisting of: equipment purchase services, equipment upgrade services, equipment maintenance services, energy use monitoring products, and energy use monitoring services.

18. A method according to claim 13, wherein the single platform is an energy efficiency platform.

19. A method according to claim 12 further comprising increasing the marketing credibility of a utility company prior to providing the freemium.

20. A method according to claim 18, further comprising increasing a value perception of the utility.

21. A method according to claim 19, wherein increasing the marketing credibility of a utility company includes at least one selected from the group consisting of: providing consumers with information on energy efficiency, providing consumers with tips regarding energy efficiency, and providing consumers with low cost products and services.

22. A method according to claim 12, wherein the home service referral network is a contractor referral network.

23. A system for freemium-based marketing comprising:
a freemium offer module for providing a utility consumer with and offer for a freemium requiring the user to respond to the offer by the consumer;
an offer acceptance module for receiving a response to the offer from the consumer;
a data collection module in communication with the offer acceptance module and configured to collect consumer data after receiving notification from the offer acceptance module that the consumer responded to the offer;
a product and service selection module for selecting a bundle of consumer products, including home service product, based on the consumer data, and offering the consumer an opportunity to purchase products from the selected bundle; and
an freemium provider module for providing the freemium to the user.

24. A system according to claim 23, further comprising:
a program integrator for integrating at least one utility program and at least one home service program, thereby creating a single platform for the at least one utility program and at least one home service program

25. A system according to claim 23, the system further comprising a database generator for generating a database including the consumer data.

26. A system according to claim 23, the system further comprising:
a product and service bundler for bundling future products and services based on the consumer data contained within the database, and offering the future products and services to the consumer associated with the consumer data.

27. A system according to claim 23, wherein the single platform is an energy efficiency platform.

28. A system for freemium-based marketing comprising:
a freemium offer module for providing a utility consumer with and offer for a freemium requiring the consumer to respond to the offer, wherein the freemium is enrollment into a home service referral network;
an offer acceptance module for receiving a response to the offer from the consumer;
a data collection module in communication with the offer acceptance module and configured to collect consumer data after receiving notification from the offer acceptance module that the consumer responds to the offer;
a product and service selection module for selecting additional products and services based on the consumer data collected by the data collection module, and offering the consumer an opportunity to purchase the additional products and service; and
an freemium provider module for activating the freemium.

29. A system according to claim 28, further comprising:
a program integrator for integrating at least one energy efficiency program and at least one home service program, thereby creating a single energy efficiency platform for the at least one energy efficiency program and at least one home service program

30. A system according to claim 28, the system further comprising a database generator for generating a database including the consumer data.

31. A system according to claim 28, the system further comprising:
a product and service bundler for bundling future products and services based on the consumer data contained within the database, and marketing the future products and services to the consumer associated with the consumer data.

32. A system according to claim 28, wherein the single platform is an energy efficiency platform.
